(19) United States
(12) Patent Application Publication
(10) Pub. No.: US 2019/0065337 A1
(43) Pub. Date: Feb. 28, 2019

(54) LOG MANAGEMENT APPARATUS, AND LOG MANAGEMENT METHOD

(71) Applicant: FUJITSU LIMITED, Kawasaki-shi (JP)

(72) Inventors: Masato Tanabe, Kawasaki (JP); Toshihiko Oikawa, Kawasaki (JP); Yuji MORITA, Shinagawa (JP); Masato Otsuka, Kawasaki (JP)

(73) Assignee: FUJITSU LIMITED, Kawasaki-shi (JP)

(21) Appl. No.: 16/114,847

(22) Filed: Aug. 28, 2018

(30) Foreign Application Priority Data
Aug. 30, 2017 (JP) 2017-166232

(51) Int. Cl. G06F 11/34

(52) U.S. Cl. CPC G06F 11/3433; G06F 11/3476; G06F 11/3419

(57) ABSTRACT

An apparatus calculates a load index for each of a plurality of log collection target devices, based on a log generation time taken for log generation in each of the plurality of log collection target devices and a log transmission time taken for log transmission from each of the plurality of the log collection target devices, and identifies a plurality of log transmittable time ranges of the plurality of log collection target devices, based on the calculated load index. The apparatus determines an order of log transmission of the plurality of log collection target devices, based on the identified plurality of log transmittable time ranges, and determines, based on the order and the plurality of log transmittable time ranges of the plurality of log collection target devices, respective times at which the plurality of log collection target devices execute the log transmission process.

### CROSS-REFERENCE TO RELATED APPLICATION

This application is based upon and claims the benefit of priority of the prior Japanese Patent Application No. 2017-166232, filed on Aug. 30, 2017, the entire contents of which are incorporated herein by reference.

### FIELD

The embodiment discussed herein is related to a log management apparatus, and a log management method.

### BACKGROUND

There is an automatic support function that monitors the operation of a storage device and addresses latent issues of the storage device. FIG. 17 is a diagram illustrating the automatic support function. As illustrated in FIG. 17, when three storage devices 92 represented as storage devices a, b, and c are set with the automatic support, the storage devices 92 transmit logs to a cloud 93, and the cloud 93 analyzes the logs and notifies a system manager managing the storage devices 92 of analysis results.

Herein, the cloud 93 is a computer system that provides computer resources with a computer network as a basis therefor. The storage devices 92 execute the log transmission at a given time specified by the system manager, at a set regular time, in the event of trouble, or when rebooting, for example.

Further, there is a log management system that allocates the time of data transmission from a user device having the highest communication load to a time slot in which there is a communication band available for data reception from the device, to thereby avoid the concentration of log collections in one time period.

Further, there is a technique of quantifying the usage status of an information processing device as an index value, and selecting a time slot in which the index value equals or exceeds a predetermined reference index value as a time slot for executing a management program, to thereby execute the management program in an appropriate time slot.

Related art includes Japanese Laid-open Patent Publication No. 2016-110280 and International Publication Pamphlet No. WO 2005/033940.

### SUMMARY

According to an aspect of the invention, an apparatus calculates a load index for each of a plurality of log collection target devices, based on a log generation time taken for log generation in each of the plurality of log collection target devices and a log transmission time taken for log transmission from each of the plurality of the log collection target devices, and identifies a plurality of log transmittable time ranges of the plurality of log collection target devices, based on the calculated load index. The apparatus determines an order of log transmission of the plurality of log collection target devices, based on the identified plurality of log transmittable time ranges, and determines, based on the order and the plurality of log transmittable time ranges of the plurality of log collection target devices, respective times at which the plurality of log collection target devices execute the log transmission process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a log collecting system according to an embodiment example;

FIG. 2 is a diagram illustrating a functional configuration of the log collecting system;

FIG. 3 is a diagram illustrating a functional configuration of a log analyzing unit;

FIG. 4 is a table illustrating an example of log generation times and log transmission times for one month;

FIG. 5 includes graphs illustrating an example of transitions of a CPU usage rate, a memory usage rate, a DBR, and an LATI value within a day;

FIG. 6 is a table illustrating CPU usage rates, memory usage rates, DBRs, and LATI values from 11:00 to 11:50;

FIG. 7 is a graph illustrating transition of an LI value on November 1;

FIG. 8 is a graph illustrating transitions of the LI value on November 1, November 2, November 3, November 4, and November 5;

FIG. 9 is a graph illustrating an example of transition of an LIA value;

FIG. 10 includes graphs illustrating transitions of LIA values of storage devices B to E;

FIG. 11 is a diagram illustrating transmittable time ranges of storage devices A to E;

FIG. 12 is a diagram illustrating transmittable time ranges of the storage devices A to E obtained by increasing the range of neighboring values;

FIGS. 13A-1 and 13A-2 together depict a first sequence diagram illustrating a sequence of processes of the log collecting system;

FIGS. 13B-1 and 13B-2 together depict a second sequence diagram illustrating the sequence of processes of the log collecting system;

FIGS. 13C-1 and 13C-2 together depict a third sequence diagram illustrating the sequence of processes of the log collecting system;

FIG. 14 is a flowchart illustrating flow of a log transmission start time determination process;

FIG. 15 is a flowchart illustrating flow of an order arrangement process;

FIG. 16 is a diagram illustrating a hardware configuration of a computer that executes a log management program according to the embodiment example; and

FIG. 17 is a diagram illustrating an automatic support function.

### DESCRIPTION OF EMBODIMENT

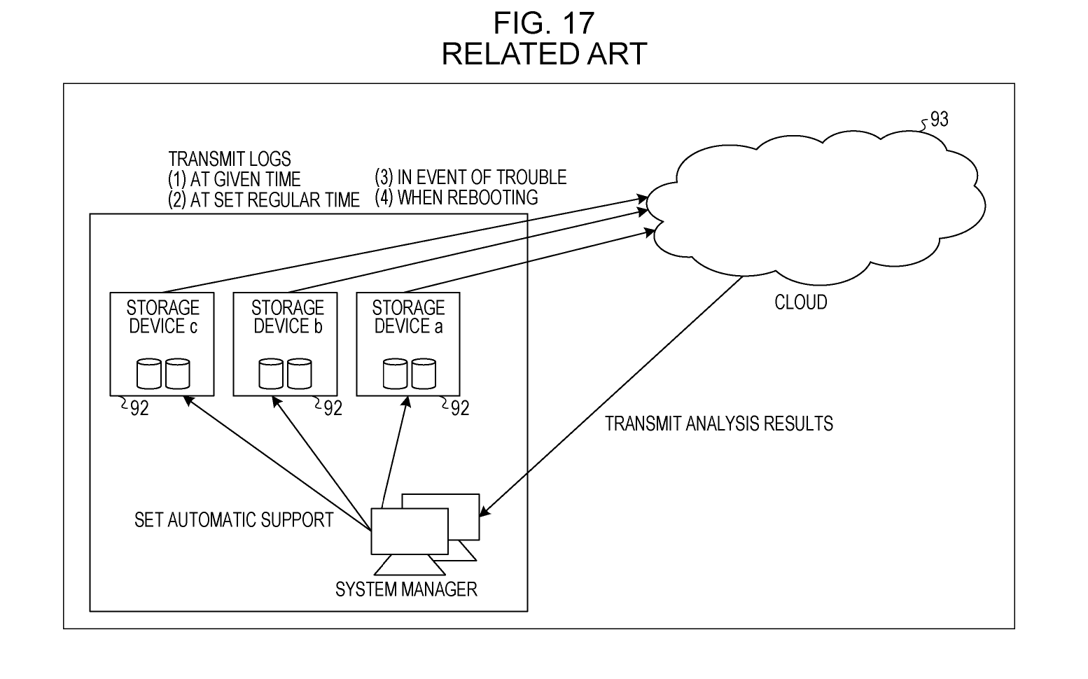

The automatic support function illustrated in FIG. 17 has an issue in that, if the storage devices 92 transmit the logs at inappropriate times, a business operation using the storage devices 92 is affected and degraded in performance.

An object of an aspect of the embodiment discussed herein is to reduce the degradation in performance of the business operation due to the log transmission.

An embodiment example of a log management apparatus, a log management method, and a log management program disclosed in the present application will be described in detail below based on the drawings. The embodiment example does not limit the disclosed techniques.

### Embodiment Example

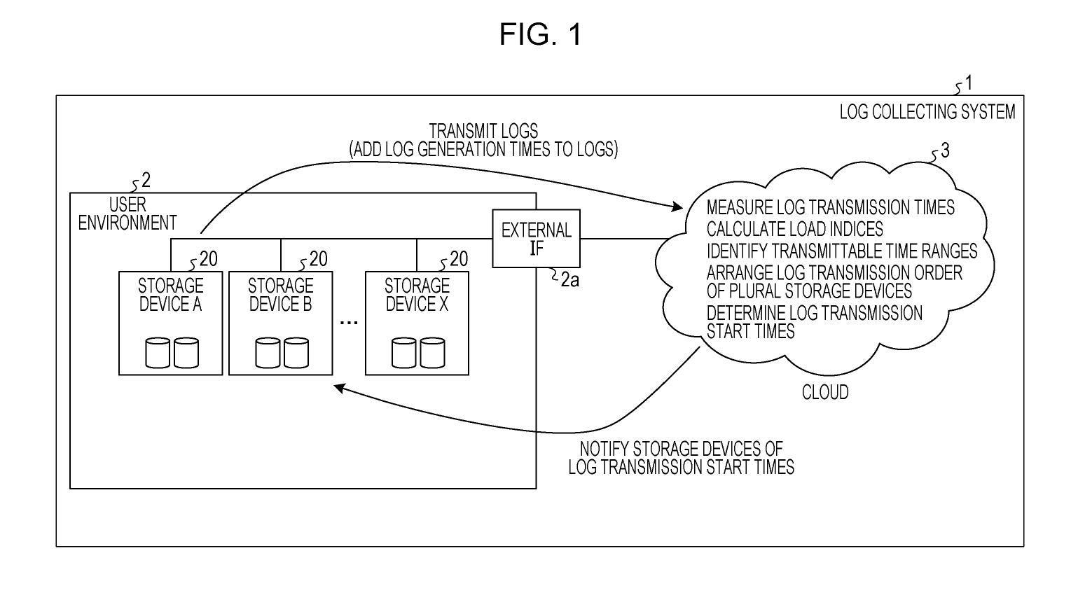

A log collecting system according to an embodiment example will first be described. FIG. 1 is a diagram illustrating the log collecting system according to the embodiment example. As illustrated in FIG. 1, a log collecting system 1 includes a user environment 2 and a cloud 3. The user environment 2 includes a plurality of storage devices 20 represented as storage devices A, B, . . . , and X. Each of the storage devices 20 stores data for use in a business operation, for example, and is managed by a system manager.

The storage device 20 collects a log with the automatic support function, and transmits the log to the cloud 3 via an external interface (IF) 2a of the user environment 2. The storage device 20 measures a log generation time taken for log generation from the start to the completion of the generation of the log, and transmits to the cloud 3 the log added with the log generation time.

The cloud 3 measures the time from the start to the completion of reception of the log as a log transmission time taken for the log transmission. The cloud 3 then calculates a load index of the storage device 20 based on the log, the log generation time, and the log transmission time. Details of the load index will be described later. Then, the cloud 3 identifies a transmittable time range of the storage device 20 based on the load index, and arranges the order of log transmission of the plurality of storage devices 20 based on the transmittable time range and the load index. Herein, the transmittable time range refers to the time range in which the storage device 20 is capable of transmitting the log. The cloud 3 then determines a log transmission start time of the storage device 20 based on the order of log transmission and the transmittable time range, and notifies the storage device 20 of the log transmission start time. Herein, the log transmission start time refers to the time at which a process of generating and transmitting the log starts. The log transmission start time may be the time at which a process of transmitting the log starts.

The cloud 3 thus calculates the load index of the storage device 20 based on the log, the log generation time, and the log transmission time, identifies the transmittable time range, and arranges the order of log transmission. The cloud 3 then determines the log transmission start time of the storage device 20 based on the order of log transmission, the transmittable time range, and the load index. Accordingly, the log collecting system 1 is capable of collecting logs while reducing adverse effects on the business operation using the storage devices 20.

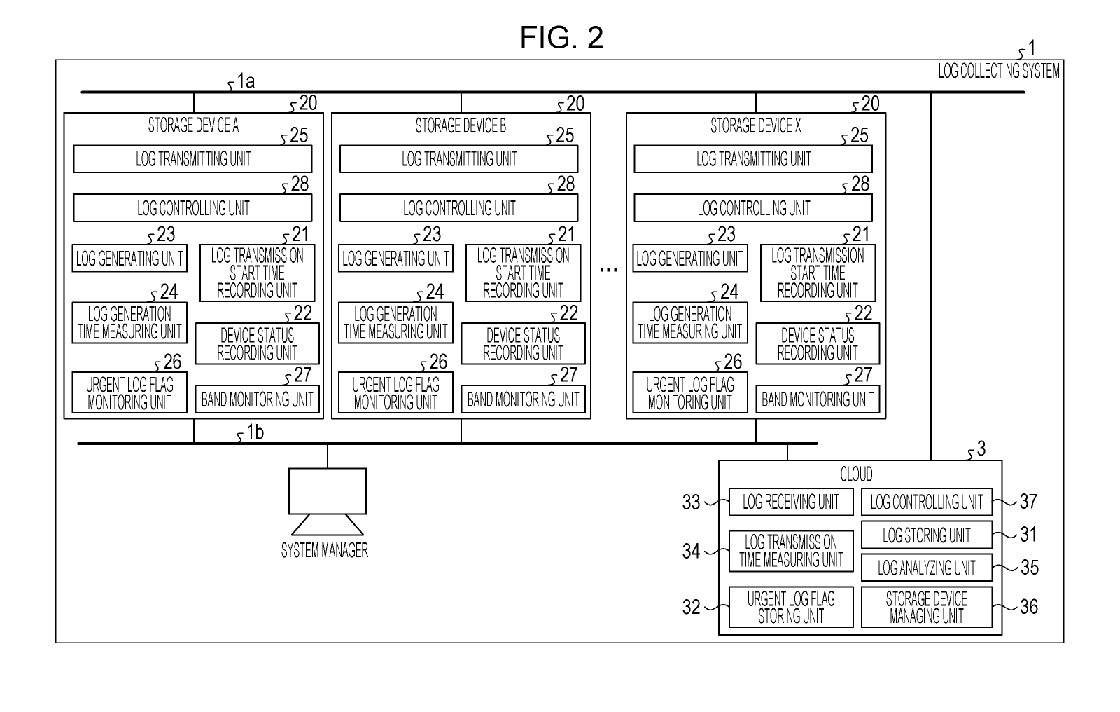

A functional configuration of the log collecting system 1 will now be described. FIG. 2 is a diagram illustrating the functional configuration of the log collecting system 1. As illustrated in FIG. 2, the log collecting system 1 includes the plurality of storage devices 20 and the cloud 3.

The plurality of storage devices 20 and the cloud 3 are connected by a network 1a. The plurality of storage devices 20 and the cloud 3 are also connected by a management network 1b. The system manager manages the plurality of storage devices 20 with the management network 1b.

Each of the storage devices 20 includes a log transmission start time recording unit 21, a device status recording unit 22, a log generating unit 23, a log generation time measuring unit 24, a log transmitting unit 25, an urgent log flag monitoring unit 26, a band monitoring unit 27, and a log controlling unit 28.

The log transmission start time recording unit 21 stores the log transmission start time notified by the cloud 3. In response to a query from the log controlling unit 28, the log transmission start time recording unit 21 transmits the log transmission start time to the log controlling unit 28.

The device status recording unit 22 stores the status of the storage device 20. When there is an urgent log, the device status recording unit 22 stores an urgent log flag. In response to a query from the urgent log flag monitoring unit 26, the device status recording unit 22 transmits the urgent log flag to the urgent log flag monitoring unit 26. The device status recording unit 22 stores a transmission band of a wide area network (WAN) for use in the log transmission to the cloud 3. In response to a query from the band monitoring unit 27, the device status recording unit 22 transmits the WAN transmission band to the band monitoring unit 27.

The log generating unit 23 generates the log based on an instruction from the log controlling unit 28. The log includes a latency, a central processing unit (CPU) usage rate, a memory usage rate, and a disk busy rate (DBR). The latency refers to the time from the reception by the storage device 20 of an access request to the response thereto by the storage device 20, for example. The log further includes information such as a fault, a hardware error, a software error, an event occurrence status such as a user operation, and storage performance information (an input/output per second (IOPS) and a data transfer speed) of the storage device 20.

The log generating unit 23 instructs the log generation time measuring unit 24 to start measuring time when starting the log generation, and instructs the log generation time measuring unit 24 to stop measuring time when completing the log generation.

The log generation time measuring unit 24 measures the time taken for the log generation based on the instruction from the log generating unit 23. In response to a query from the log controlling unit 28, the log generation time measuring unit 24 transmits the measured time to the log controlling unit 28. The log transmitting unit 25 transmits the log to the cloud 3 based on an instruction from the log controlling unit 28.

The urgent log flag monitoring unit 26 queries the device status recording unit 22 for the urgent log flag based on an instruction from the cloud 3. The urgent log flag monitoring unit 26 instructs the band monitoring unit 27 to acquire the WAN transmission band. The band monitoring unit 27 queries the device status recording unit 22 for the WAN transmission band. The band monitoring unit 27 then notifies the cloud 3 of the presence or absence of the urgent log flag and the WAN transmission band as the device status.

The log controlling unit 28 controls the log transmission. That is, the log controlling unit 28 queries the log transmission start time recording unit 21 for the log transmission start time. When the log transmission start time comes, the log controlling unit 28 instructs the log generating unit 23 to generate the log. The log controlling unit 28 further queries the log generation time measuring unit 24 for the log generation time, adds the log generation time to the log generated by the log generating unit 23, establishes connection with the cloud 3, and instructs the log transmitting unit 25 to transmit the log.

The cloud 3 includes a log storing unit 31, an urgent log flag storing unit 32, a log receiving unit 33, a log transmission time measuring unit 34, a log analyzing unit 35, a storage device managing unit 36, and a log controlling unit 37.

The log storing unit 31 stores the log and the log transmission time based on an instruction from the log controlling unit 37. The urgent log flag storing unit 32 stores the device status acquired from the storage device 20 by the storage device managing unit 36.

The log receiving unit 33 receives the log transmitted by the storage device 20, and delivers the received log to the log storing unit 31. The log transmission time measuring unit 34 measures the time taken for the log transmission based on an instruction from the log controlling unit 37. The log analyzing unit 35 determines the log transmission start time of the storage device 20 based on the log stored in the log storing unit 31, and notifies the storage device 20 of the determined log transmission start time.

The storage device managing unit 36 periodically instructs the storage device 20 to execute the updating of the device status including the updating of the urgent log flag, and receives the device status from the storage device 20. Herein, “periodically” means “at predetermined time intervals,” for example. The storage device managing unit 36 then instructs the urgent log flag storing unit 32 to store the device status.

The log controlling unit 37 controls the reception, storage, and analysis of the log. That is, when the log controlling unit 37 detects the start of the reception of the log, the log controlling unit 37 instructs the log transmission time measuring unit 34 to measure the time taken for the log transmission. Further, when the reception of the log is completed, the log controlling unit 37 instructs the log storing unit 31 to store the log. The log controlling unit 37 further instructs the log storing unit 31 to store the log transmission time measured by the log transmission time measuring unit 34. Further, the log controlling unit 37 instructs the log analyzing unit 35 to analyze the log and determine the log transmission start time. The log controlling unit 37 further transmits the log transmission start time to the storage device 20.

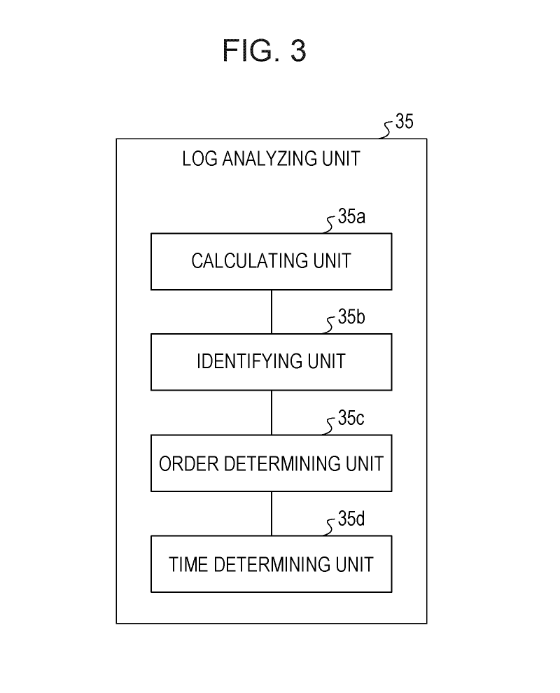

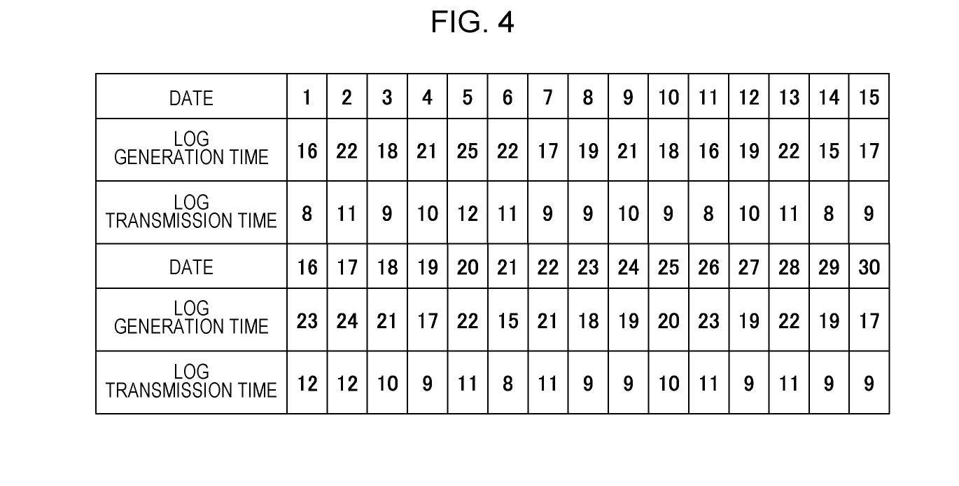

Details of the log analyzing unit 35 will now be described. FIG. 3 is a diagram illustrating a functional configuration of the log analyzing unit 35. As illustrated in FIG. 3, the log analyzing unit 35 includes a calculating unit 35a, an identifying unit 35b, an order determining unit 35c, and a time determining unit 35d.

The calculating unit 35a calculates the load index of the storage device 20 based on the log generation time, the log transmission time, and the log. Specifically, the calculating unit 35a acquires from the log storing unit 31 the transition of the latency, the transition of the CPU usage rate, the transition of the memory usage rate, and the transition of the DBR of the storage device 20 for the past one month. The calculating unit 35a handles acquired values as divided by a predetermined time interval. The predetermined time interval is 10 minutes, for example. Further, the past one month is illustrative, and may be replaced by a different period.

The calculating unit 35a further acquires from the log storing unit 31 log generation times and log transmission times in respective log generation and transmission processes for the past one month. FIG. 4 is a table illustrating an example of log generation times and log transmission times for one month. It is assumed here that the log is transmitted once a day. Further, in FIG. 4, the log generation times and the log transmission times are expressed in units of minutes, and the numbers in “DATE” rows represent dates. Further, FIG. 4 illustrates data for one month (30 days) from November 1 to November 30. For example, the log generation time and the log transmission time on November 1 are 16 minutes and 8 minutes, respectively.

Then, the calculating unit 35a estimates the log generation time and the log transmission time for the next day based on the log generation times and the log transmission times for the one month. The calculating unit 35a determines a log generation time (LGT) equaling the mean log generation time for the past one month as the estimated value of the log generation time, and determines a log transmission time (LTT) equaling the mean log transmission time for the past one month as the estimated value of the log transmission time.

In the case of the log generation times and the log transmission times illustrated in FIG. 4, the LGT is expressed as LGT=(16+22+18+ . . . +22+19+17)/30=588/30=19.6≈20 and the LTT is expressed as LTT=(8+11+9+ . . . +11+9+9)/30=294/30≈10.

With the following equation (1), the calculating unit 35a then calculates a load index LIₘ at a time m in each of the days in the one month.

LIₘ=(Σ_{m=m to m+(LGT+LTT)}(CPUₘ/3+MEMₘ/3+DBRₘ/3)×LATIₘ)/=number of data items during (m=m to m+(LGT+LTT)) (1)

Herein, CPUₘ, MEMₘ, and DBRₘ represent the CPU usage rate, the memory usage rate, and the DBR at the time m, respectively, and are expressed in units of percentage (%). Each of CPUₘ, MEMₘ, and DBRₘ is divided by three to calculate the mean of the sum of the values of the three elements CPUₘ, MEMₘ, and DBRₘ. Further, each of CPUₘ, MEMₘ, and DBRₘ does not affect the business operation when being less than a certain value, and thus is considered as zero when being less than a predetermined threshold (80%, for example).

LATIₘ represents the value obtained by dividing a latency LATₘ at the time m by the mean latency for the past one month. The reference value of a latency LAT varies depending on whether an employed drive is the solid state drive (SSD) or the hard disk drive (HDD), which depends on the environment in which the drive is used. Therefore, the mean value for the one month is set as the reference value, and LATIₘ as the ratio of the latency LATₘ thereto is used. When the LATₘ value at the time m exceeds the mean latency for the past one month, the LATIₘ value exceeds 1.0. Conversely, when the LATₘ value at the time m falls below the mean latency for the past one month, the LATIₘ value falls below 1.0.

The load index LIₘ represents a value based on a load imposed on the storage device 20 during the period from the generation to the transmission of the log with the time m serving as a transmission start time point. Specifically, the load index LIₘ represents the value obtained by summing up values based on the CPU usage rate, the memory usage rate, the DBR, and the latency during the period from the time m to a time (m+(LGT+LTT)). Further, the data is handled as divided by a certain time interval, and thus the number of data items varies with the number of divisions. To remove the variation with the number of divisions, the load index LIₘ is divided by the number of data items during the period from the time m to the time (m+(LGT+LTT)) to be normalized.

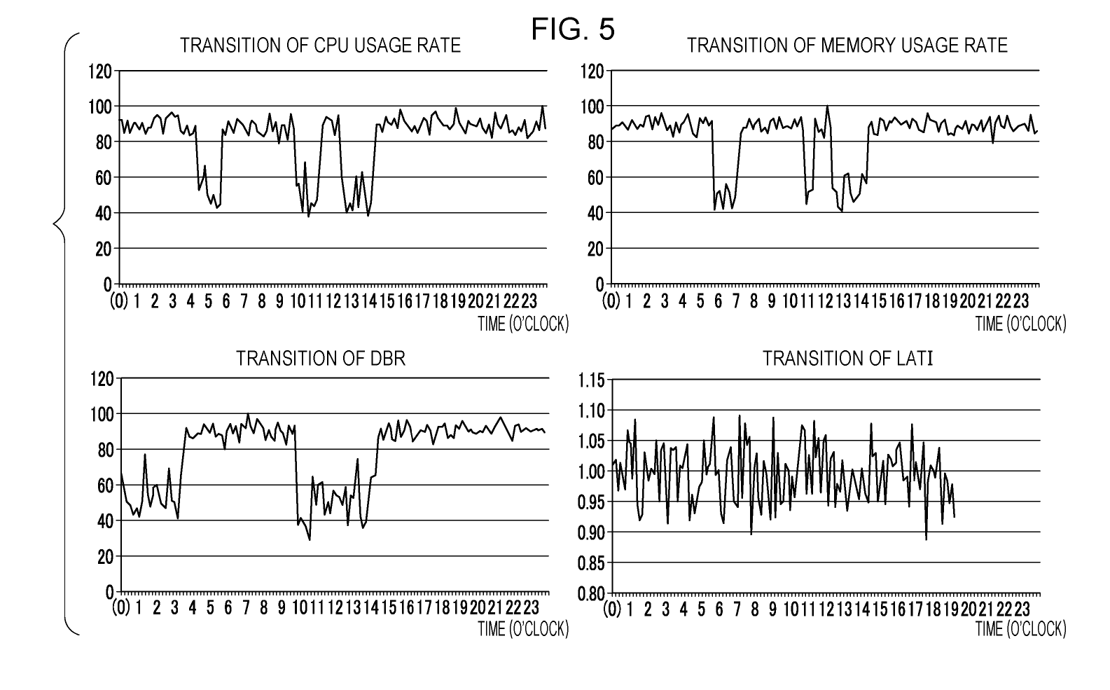

FIG. 5 includes graphs illustrating an example of transitions of the CPU usage rate, the memory usage rate, the DBR, and a LATI value within a day. FIG. 5 illustrates data on November 1. The horizontal axis represents the time. The vertical axis represents the CPU usage rate, the memory usage rate, the DBR, or the LATI value. On the vertical axis, the CPU usage rate, the memory usage rate, and the DBR are expressed in units of percentage (%).

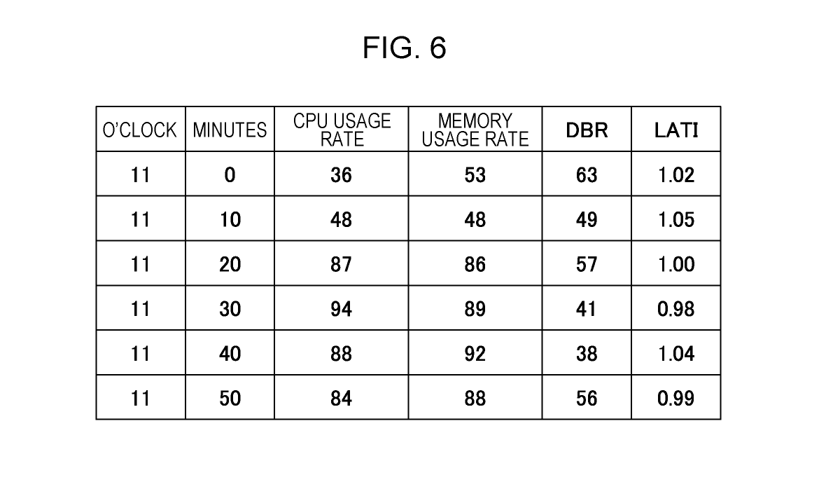

FIG. 6 is a table illustrating CPU usage rates, memory usage rates, DBRs, and LATI values from 11:00 to 11:50. In FIG. 6, the data is handled at intervals of 10 minutes. For example, the CPU usage rate, the memory usage rate, the DBR, and the LATI value at 11:00 are 36%, 53%, 63%, and 1.02, respectively.

The number of data items during the period from the time m to the time (m+(LGT+LTT)) is three. With the value (LGT+LTT=30) calculated based on the data in FIG. 4, therefore, the value of LI_{11:30} is calculated as follows:

LI_{11:30}=((CPU_{11:30}/3+MEM_{11:30}/3+DBR_{11:30}/3)×LATI_{11:30}+(CPU_{11:40}/3+MEM_{11:40}/3+DBR_{11:40}/3)×LATI_{11:40}+(CPU_{11:50}/3+MEM_{11:50}/3+DBR_{11:50}/3)×LATI_{11:50})/3=((94/3+89/3+41/3)×0.98+(88/3+92/3+38/3)×1.04+(84/3+88/3+56/3)×0.99)/3

Herein, when the values of CPUₘ, MEMₘ, and DBRₘ less than 80% are considered as zero, the value of LI_{11:30} is calculated as follows:

LI_{11:30}=((94/3+89/3+0)×0.98+(88/3+92/3+0)×1.04+(84/3+88/3+0)×0.99)/3≈59.6

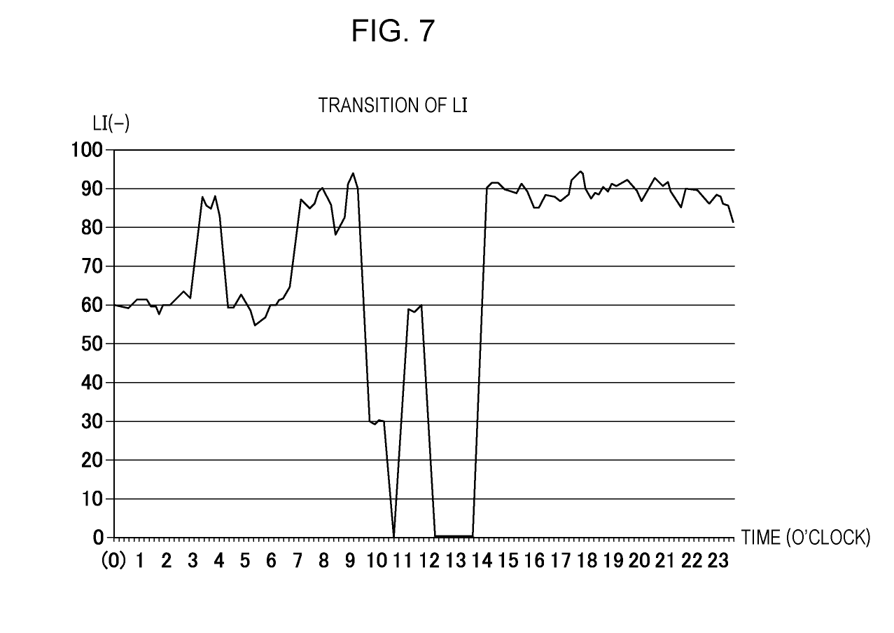

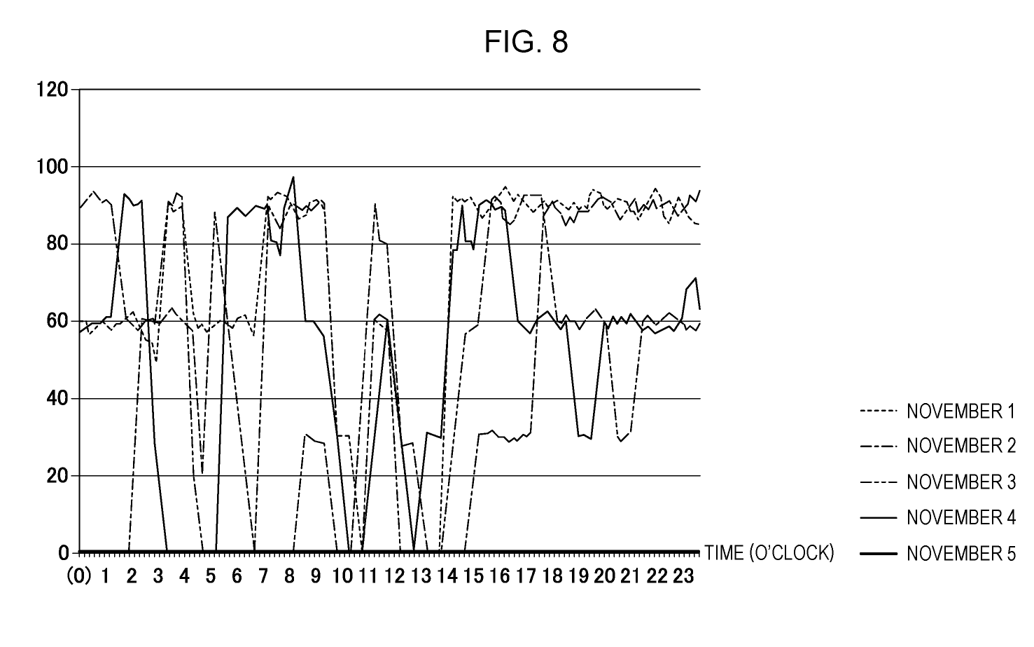

The transition of the LI value on November 1 is obtained by executing calculation similar to the above-described calculation for each of times 00:00 to 23:50. FIG. 7 is a graph illustrating the transition of the LI value on November 1. The horizontal axis represents the time, and the vertical axis represents the LI value. The transition of the LI value on each of the days in November is obtained in a similar manner. FIG. 8 is a graph illustrating transitions of the LI value on November 1, November 2, November 3, November 4, and November 5.

With the following equation (2), the calculating unit 35a then calculates a LIAₘ value, which is the mean for the one month, with the LIₘ values for the respective days in the month.

LIAₘ=Σ_{d=1 to 30}(LI_{d,m})/30 (2)

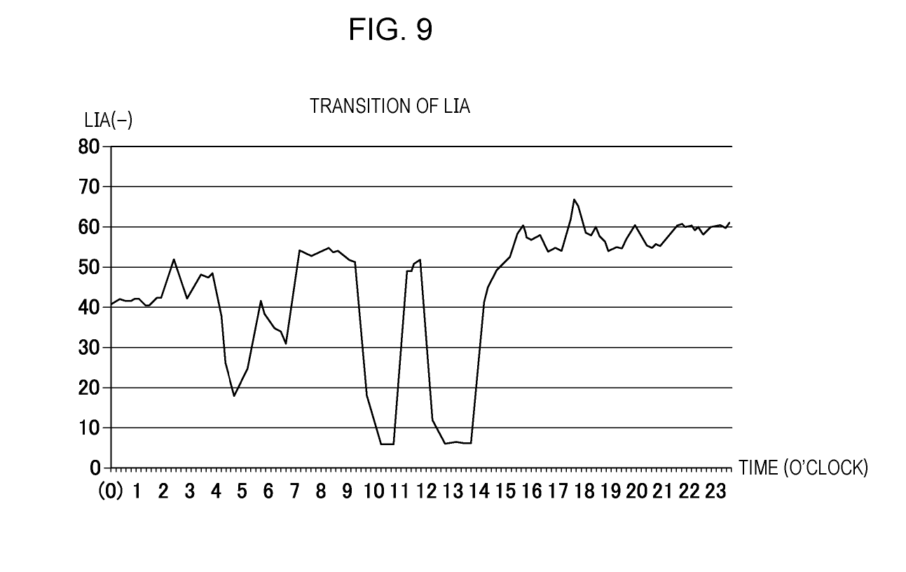

The calculating unit 35a then calculates the LIAₘ value at the time m for each of the time intervals in a day. FIG. 9 is a graph illustrating an example of transition of the LIA value. The horizontal axis represents the time, and the vertical axis represents the LIA value.

The identifying unit 35b identifies the transmittable time range based on the load index. Specifically, the identifying unit 35b determines, as candidates for the log transmission start time, the time corresponding to the minimum value of LIAₘ calculated by the calculating unit 35a and the times corresponding to neighboring values of the minimum value (LIA values greater than the minimum value by 10 or less, for example). If the candidates for the log transmission start time include sequential times, the identifying unit 35b identifies the range of sequential candidate times as one transmittable time range. In FIG. 9, the minimum LIA value is appropriately six near 13:00. The LIA value does not exceed 16 in periods 10:00 to 11:00 and 12:30 to 14:00. Therefore, each of the periods 10:00 to 11:00 and 12:30 to 14:00 is the transmittable time range.

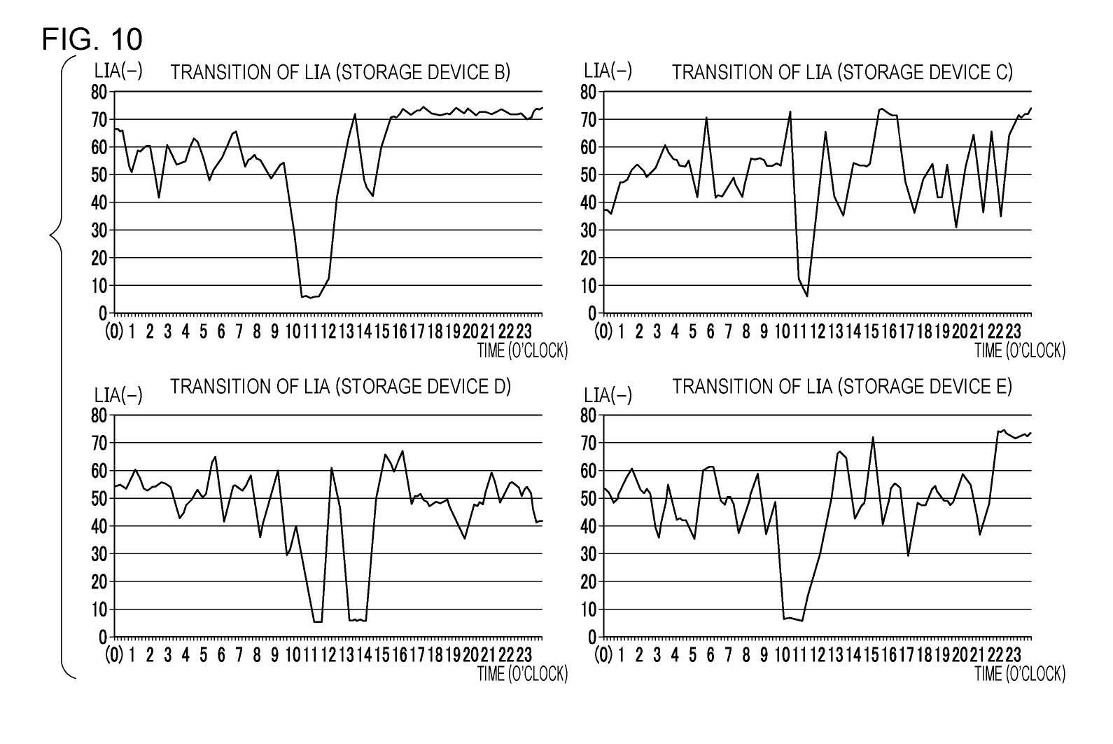

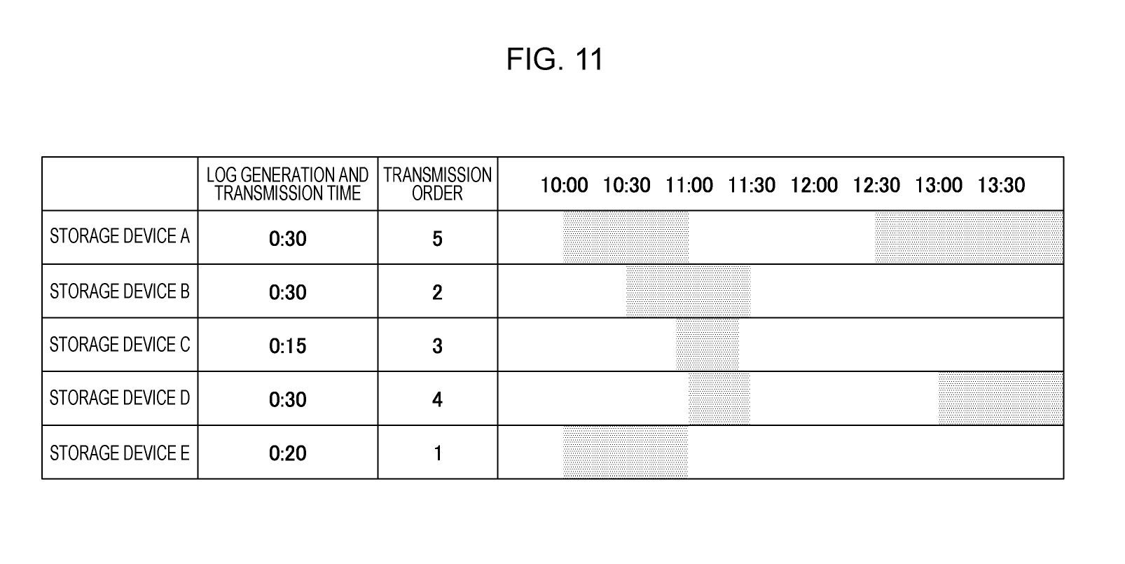

The calculating unit 35a calculates the respective LIA values of all of the storage devices 20 in the user environment 2. FIG. 10 includes graphs illustrating transitions of LIA values of the storage devices B to E. The identifying unit 35b then identifies the respective transmittable time ranges of the storage devices 20. FIG. 11 is a diagram illustrating transmittable time ranges of the storage devices A to E. In FIG. 11, hatched areas represent the transmittable time ranges. The transition of the LIA value of the storage device A in FIG. 11 corresponds to the transition of the LIA value illustrated in FIG. 9.

The order determining unit 35c determines the order of log transmission for all of the storage devices 20 in the user environment 2 based on the transmittable time range, a log generation and transmission time (LGT+LTT), and the load index. If the log transmission from only one of the storage devices 20 is executable at a time with the WAN band available for the log transmission and the band taken for the log transmission, the storage devices 20 execute the log transmission in the order determined by the order determining unit 35c. It is assumed in the following description that the log transmission from only one of the storage devices 20 is executable at a time.

The order determining unit 35c basically determines the order of log transmission based on the order of earliest end time of the transmittable time range of the storage devices 20. Further, if two or more of the storage devices 20 have the same end time of the transmittable time range, the order determining unit 35c determines the order of log transmission based on the order of smallest sum of LIA values of all of the storage devices 20.

Further, if there is a vacant time between the completion of log transmission from one of the storage devices 20 and the start of log transmission from the next one of the storage devices 20, the order determining unit 35c prioritizes, in order, another one of the storage devices 20 capable of executing the log transmission and completing the log transmission within the vacant time. Whether a storage device 20 is capable of completing the log transmission within the vacant time is determined based on the transmittable time range and the log generation and transmission time.

For example, in FIG. 11, the storage device E has the earliest end time of the transmittable time range, which is 11:00. The order determining unit 35c therefore determines the storage device E as the first storage device 20 to execute the transmission. The storage device C has the next earliest end time (11:20). However, the storage device B is capable of starting the transmission at 10:30, and has a log generation and transmission time of 30 minutes. The storage device B is therefore capable of completing the log transmission at 11:00, at which the storage device C is capable of starting the log transmission. The order determining unit 35c therefore determines the storage device B as the second storage device 20 to execute the transmission, and determines the storage device C as the third storage device 20 to execute the transmission.

Further, the storage devices A and D have the same end time of the transmittable time range, which is 14:00. The order determining unit 35c therefore calculates the sum of LIA values of all of the storage devices 20 for each of a case in which the storage device A is prioritized in order and a case in which the storage device D is prioritized in order. The total LIA value for the case in which the transmission from the storage device A is prioritized in order is calculated as follows:

Total LIA value=LIA_{10:00} of storage device E+LIA_{10:30} of storage device B+LIA_{11:00} of storage device C+LIA_{12:30} of storage device A+LIA_{13:00} of storage device D=8+8+10+10+8=44

Meanwhile, the total LIA value for the case in which the transmission from the storage device D is prioritized in order is calculated as follows:

Total LIA value=LIA_{10:00} of storage device E+LIA_{10:30} of storage device B+LIA_{11:00} of storage device C+LIA_{13:00} of storage device D+LIA_{13:30} of storage device A=8+8+10+8+8=42

The order determining unit 35c therefore selects the case of the smaller total LIA value of 42, that is, the case in which the transmission from the storage device D is prioritized in order. Thus, the order determining unit 35c determines the storage device D as the fourth storage device 20 to execute the transmission, and determines the storage device A as the fifth storage device 20 to execute the transmission.

Further, if any of the storage devices 20 has an urgent log, the order determining unit 35c divides the storage devices 20 into a group of storage devices 20 with the urgent log and a group of storage devices 20 without the urgent log, and arranges the order within each of the groups. Further, the order determining unit 35c prioritizes, in order, the storage devices 20 with the urgent log over the storage devices 20 without the urgent log.

If any of the storage devices 20 is unable to complete the log transmission within the transmittable time range, the log analyzing unit 35 increases the range of neighboring values of the minimum LIA value. For example, if LIA values greater than the minimum value by 10 or less are set as the neighboring values, the log analyzing unit 35 resets the neighboring values as values greater than the minimum value by 15 or less.

For example, if the storage device A has the urgent log in FIG. 11, the storage device A starts generating and transmitting the log at 10:00. Then, the storage device E starts generating and transmitting the log at 10:30, and the storage device C starts generating and transmitting the log at 11:00. Since the storage device C completes the log transmission at 11:15, the storage device B starts the log generation at 11:15. However, the storage device B has a log generation and transmission time of 30 minutes, and thus is unable to complete the log transmission by 11:30, which is the end time of the transmittable time range of the storage device B. Therefore, the log analyzing unit 35 sets LIA values greater than the minimum value by 15 or less as the neighboring values.

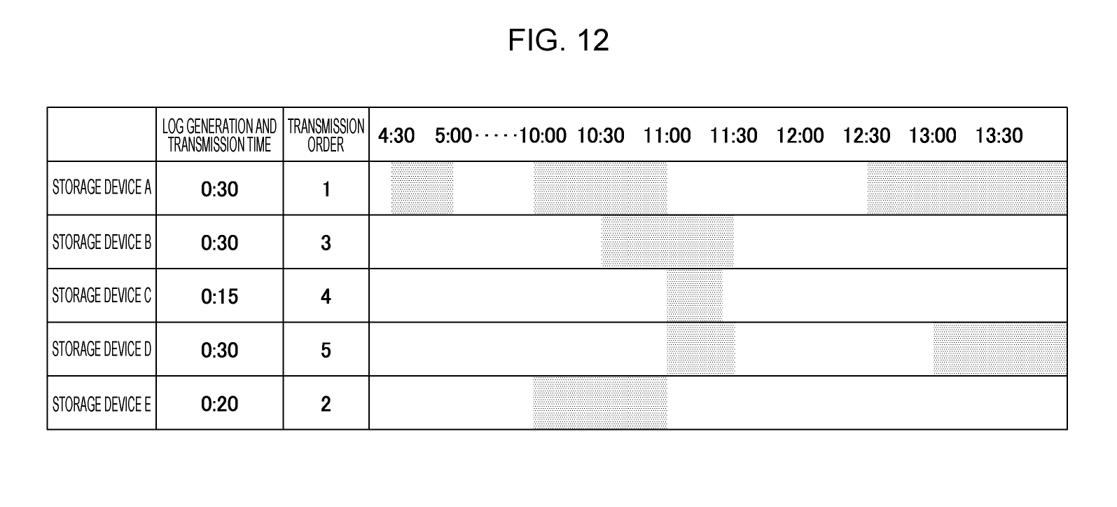

FIG. 12 is a diagram illustrating transmittable time ranges of the storage devices A to E obtained by increasing the range of neighboring values. In FIG. 12, the transmittable time range of the storage device A is increased to include a range from 4:30 to 5:00, as compared with that in FIG. 11. Consequently, the storage device A starts generating and transmitting the log at 4:30, and the storage device E starts generating and transmitting the log at 10:00. Then, the storage device B starts generating and transmitting the log at 10:30, and the storage device C starts generating and transmitting the log at 11:00. Then, the storage device D starts generating and transmitting the log at 13:00. Accordingly, all of the storage devices 20 are capable of completing the log transmission within the respective transmittable time ranges.

Based on the transmittable time ranges and the order determined by the order determining unit 35c, the time determining unit 35d determines the respective log transmission start times of the storage devices 20 at which the storage devices 20 start generating and transmitting the log.

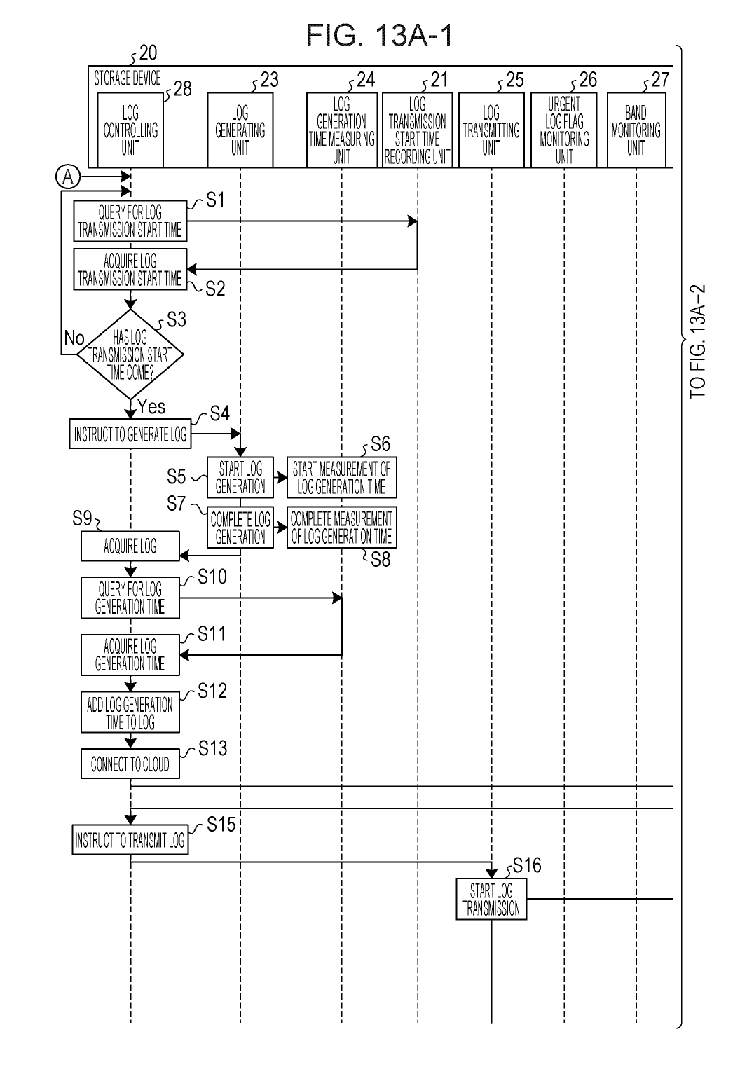

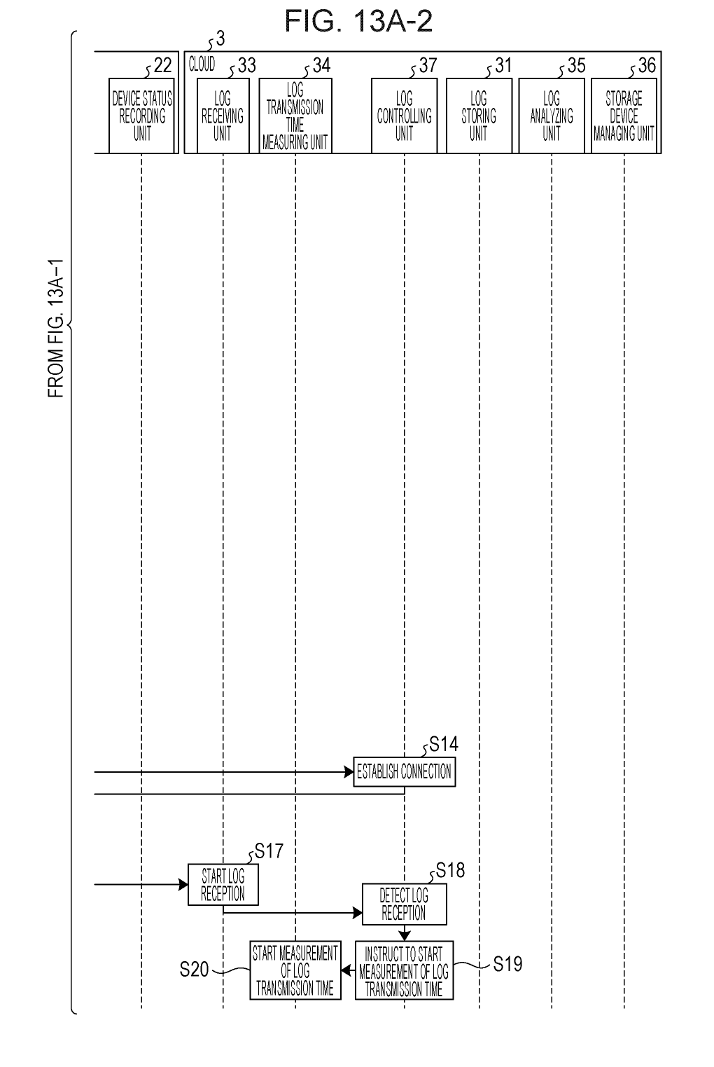

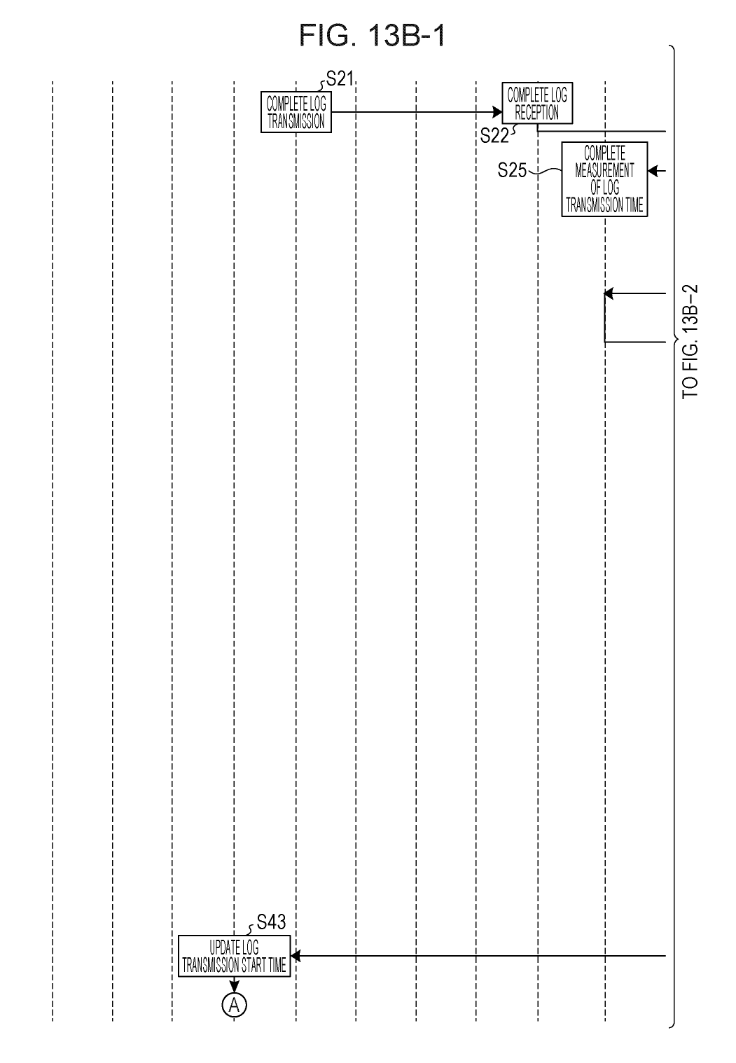

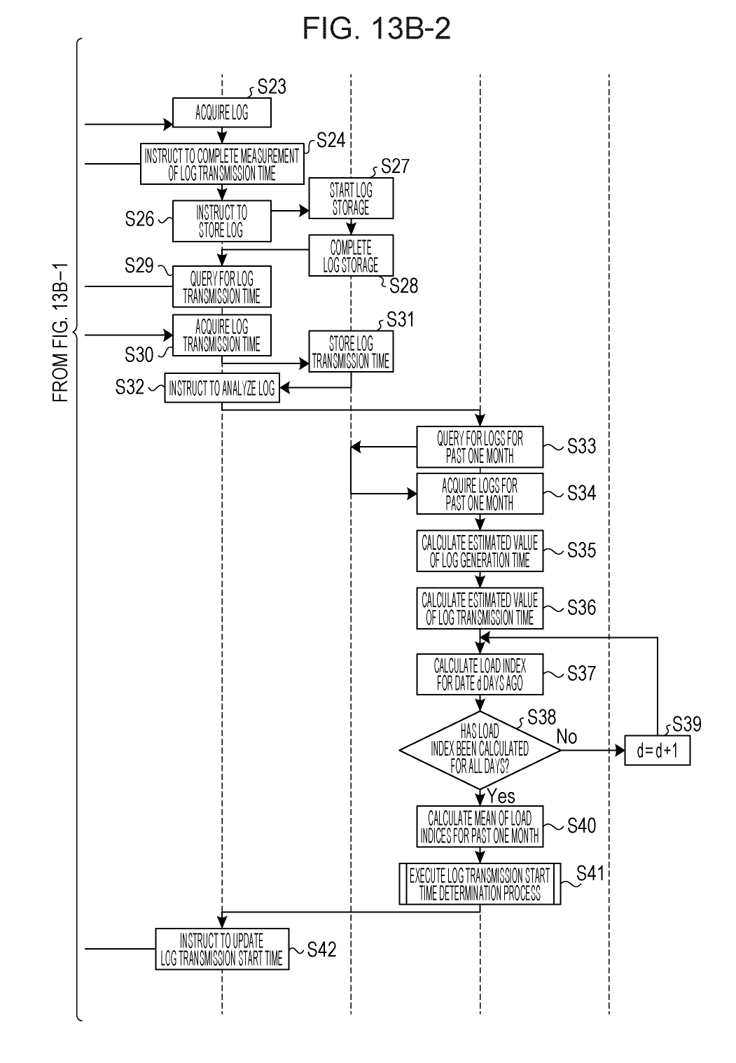

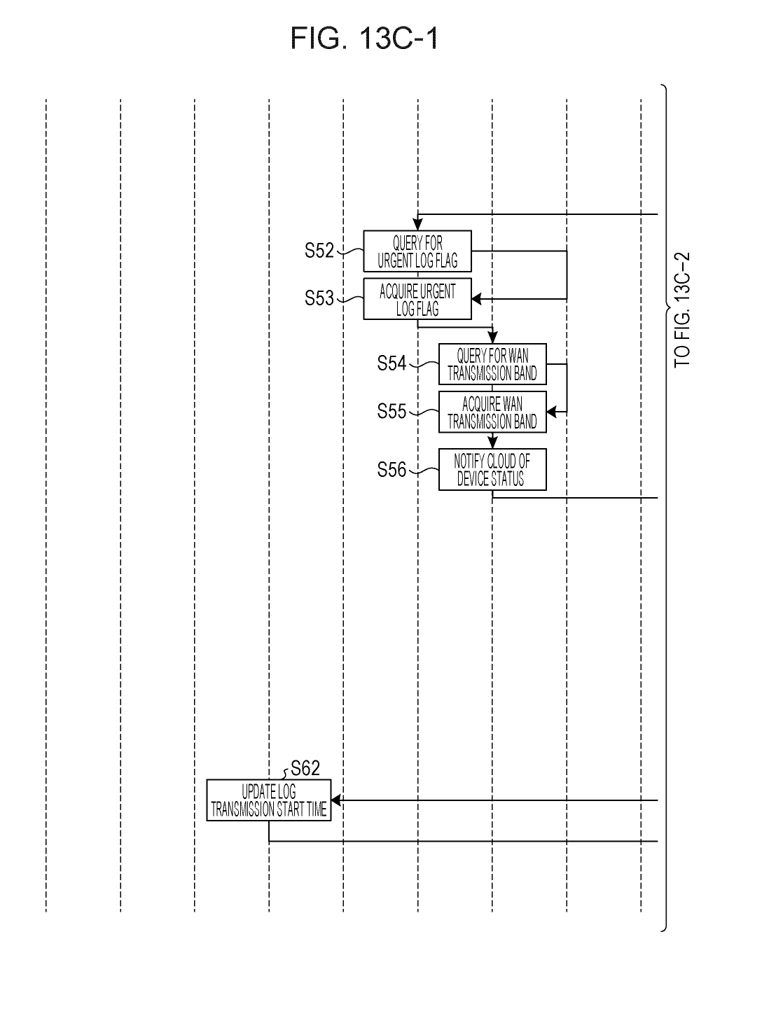

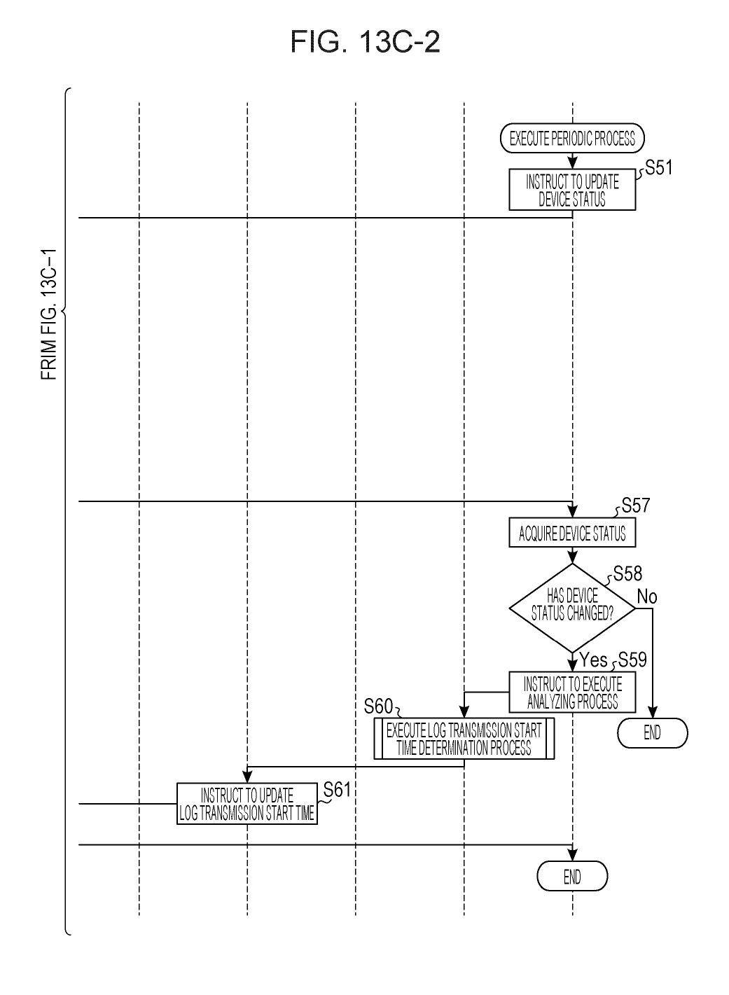

A sequence of processes of the log collecting system 1 will now be described. FIGS. 13A-1 to 13C-2 are sequence diagrams illustrating the sequence of processes of the log collecting system 1. As illustrated in FIGS. 13A-1 and 13A-2, the log controlling unit 28 of each of the storage devices 20 queries the log transmission start time recording unit 21 for the log transmission start time (step S1), and acquires the log transmission start time (step S2).

The log controlling unit 28 then determines whether the log transmission start time has come (step S3). If the log transmission start time has not come, the log controlling unit 28 returns to step S1. Meanwhile, if the log transmission start time has come, the log controlling unit 28 instructs the log generating unit 23 to generate the log (step S4).

Then, the log generating unit 23 starts generating the log (step S5), and the log generation time measuring unit 24 starts measuring the log generation time (step S6). The log generating unit 23 then completes the log generation (step S7), and the log generation time measuring unit 24 completes the measurement of the log generation time (step S8).

Then, the log controlling unit 28 acquires the log generated by the log generating unit 23 (step S9), and queries the log generation time measuring unit 24 for the log generation time (step S10). The log controlling unit 28 then acquires the log generation time from the log generation time measuring unit 24 (step S11), and adds the log generation time to the log (step S12). The log controlling unit 28 then connects to the cloud 3 (step S13). Then, the log controlling unit 37 of the cloud 3 establishes connection with the log controlling unit 28 (step S14).

The log controlling unit 28 then instructs the log transmitting unit 25 to transmit the log (step S15), and the log transmitting unit 25 starts the log transmission (step S16). Then, the log receiving unit 33 of the cloud 3 starts receiving the log (step S17) Then, the log controlling unit 37 detects the reception of the log (step S18), and instructs the log transmission time measuring unit 34 to start measuring the log transmission time (step S19). Then, the log transmission time measuring unit 34 starts measuring the log transmission time (step S20).

Then, as illustrated in FIGS. 13B-1 and 13B-2, the log transmitting unit 25 completes the log transmission (step S21), and the log receiving unit 33 completes the log reception (step S22). Then, the log controlling unit 37 acquires the log from the log receiving unit 33 (step S23), and instructs the log transmission time measuring unit 34 to complete the measurement of the log transmission time (step S24). Then, the log transmission time measuring unit 34 completes the measurement of the log transmission time (step S25).

Then, the log controlling unit 37 instructs the log storing unit 31 to store the log (step S26). Then, the log storing unit 31 starts storing the log (step S27), and completes the storage of the log (step S28). The log controlling unit 37 then queries the log transmission time measuring unit 34 for the log transmission time (step S29), and acquires the log transmission time from the log transmission time measuring unit 34 (step S30). The log controlling unit 37 then instructs the log storing unit 31 to store the log transmission time, and the log storing unit 31 stores the log transmission time (step S31). The log controlling unit 37 then instructs the log analyzing unit 35 to analyze the log (step S32).

Then, the log analyzing unit 35 queries the log storing unit 31 for the logs for the past one month (step S33), and acquires the logs for the past one month from the log storing unit 31 (step S34). The log analyzing unit 35 then calculates the estimated value of the log generation time (step S35), and calculates the estimated value of the log transmission time (step S36).

The log analyzing unit 35 then calculates the load index for the date d days ago (step S37). Herein, d represents a variable that has an initial value of zero, and increases up to 29 when one month is assumed to have 30 days, for example. The log analyzing unit 35 then determines whether the load index has been calculated for each of the days in the past one month (step S38). If the load index has not been calculated for each of the days in the past one month, the log analyzing unit 35 increments the variable d by one (step S39), and returns to step S37.

Meanwhile, if the load index has been calculated for each of the days in the past one month, the log analyzing unit 35 calculates the mean of the load indices for the past one month (step S40), and executes a log transmission start time determination process of determining the log transmission start time for each of the storage devices 20 (step S41).

Then, the log controlling unit 37 transmits the log transmission start time to the storage device 20, and instructs the storage device 20 to update the log transmission start time (step S42). Then, the log transmission start time recording unit 21 of the storage device 20 updates the log transmission start time (step S43). The storage device 20 then returns to step S1.

The log analyzing unit 35 thus analyzes the logs for the past one month, calculates the load index, and determines the log transmission start time based on the load index. Accordingly, the storage device 20 is capable of starting the log transmission at a time at which the log transmission has a low impact on the business operation.

Further, as illustrated in FIGS. 13C-1 and 13C-2, the storage device managing unit 36 of the cloud 3 periodically instructs the storage device 20 to update the device status (step S51). Then, the urgent log flag monitoring unit 26 of the storage device 20 queries the device status recording unit 22 for the urgent log flag (step S52), and acquires the urgent log flag (step S53).

Then, the band monitoring unit 27 queries the device status recording unit 22 for the WAN transmission band (step S54), and acquires the WAN transmission band (step S55). The band monitoring unit 27 then notifies the cloud 3 of the device status, which includes the urgent log flag and the WAN transmission band (step S56).

Then, the storage device managing unit 36 acquires the device status (step S57), and determines whether the device status has changed (step S58). Then, if the device status has not changed, the storage device managing unit 36 completes the process thereof.

Meanwhile, if the device status has changed, the storage device managing unit 36 instructs the log analyzing unit 35 to execute the analyzing process (step S59). Then, the log analyzing unit 35 executes the log transmission start time determination process (step S60). Then, the log controlling unit 37 transmits the log transmission start time to the storage device 20, and instructs the storage device 20 to update the log transmission start time (step S61). Then, the log transmission start time recording unit 21 of the storage device 20 updates the log transmission start time (step S62).

The storage device managing unit 36 thus acquires the device status from the storage device 20, and instructs the log analyzing unit 35 to execute the analyzing process if the device status has changed. Therefore, the log analyzing unit 35 is capable of determining the log transmission start time in accordance with the change in the storage device 20.

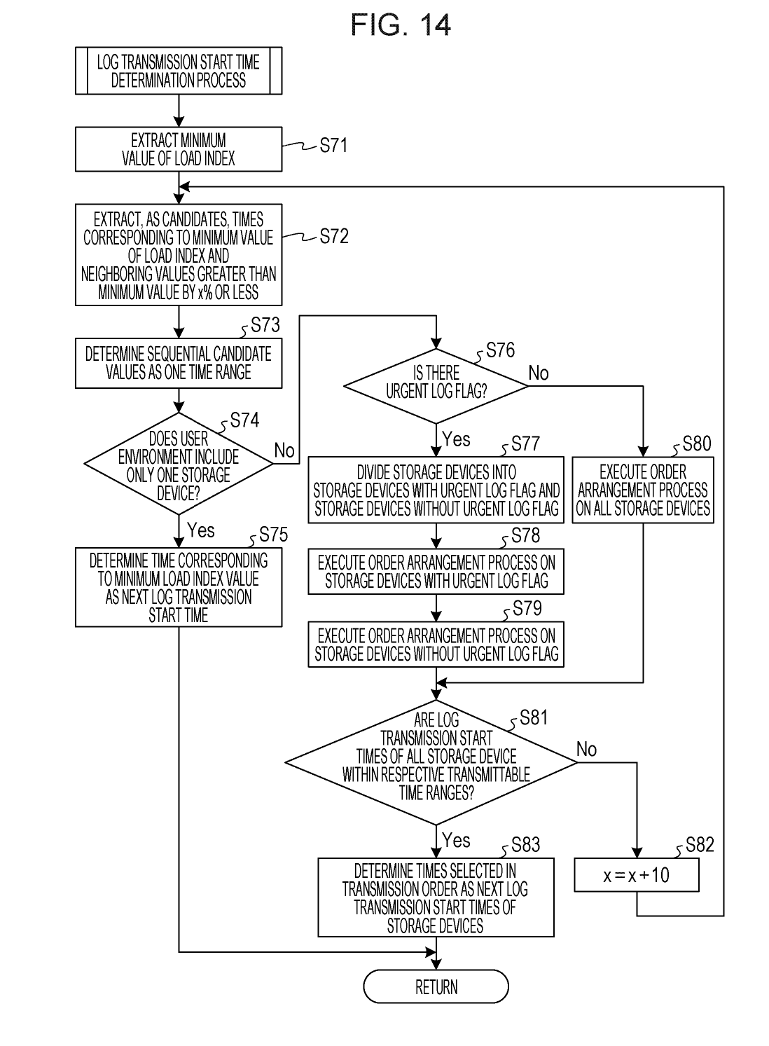

FIG. 14 is a flowchart illustrating flow of the log transmission start time determination process. As illustrated in FIG. 14, the log analyzing unit 35 extracts the minimum value of the load index (step S71), and extracts, as the candidates, the time corresponding to the minimum value of the load index and the times corresponding to neighboring values of the minimum value greater than the minimum value by x % or less (step S72). The neighboring values may be greater than the minimum value by a predetermined value y or less.

Then, if the candidates include sequential values, the log analyzing unit 35 determines the sequential values as one time range (step S73). The log analyzing unit 35 then determines whether the user environment 2 includes only one storage device 20 (step S74). If the user environment 2 includes only one storage device 20, the log analyzing unit 35 determines the time corresponding to the minimum value of the load index as the next log transmission start time (step S75), and completes the process.

Meanwhile, if the user environment 2 includes a plurality of storage devices 20, the log analyzing unit 35 determines whether any of the storage devices 20 has the urgent log flag (step S76). Then, if any of the storage devices 20 has the urgent log flag, the log analyzing unit 35 divides the storage devices 20 into a group of storage devices 20 with the urgent log flag and a group of storage devices 20 without the urgent log flag (step S77). The log analyzing unit 35 then executes an order arrangement process of arranging the order of transmission within the group of storage devices 20 with the urgent log flag (step S78), and executes the order arrangement process within the group of storage devices 20 without the urgent log flag (step S79). Meanwhile, if the storage devices 20 do not have the urgent log flag, the log analyzing unit 35 executes the order arrangement process on all of the storage devices 20 (step S80).

The log analyzing unit 35 then determines whether the log transmission start times of all of the storage devices 20 are included in the respective transmittable time ranges (step S81). If any of the storage devices 20 has the log transmission start time not included in the transmittable time range, the log analyzing unit 35 adds 10 to the value x (step S82). The log analyzing unit 35 then returns to step S72.

Meanwhile, if the log transmission start times of all of the storage devices 20 are included in the respective transmittable time ranges, the log analyzing unit 35 determines the times selected in the transmission order as the next log transmission start times of the storage devices 20 (step S83).

The log analyzing unit 35 thus determines the log transmission start time from time corresponding to the minimum value of the load index and the times corresponding to the neighboring values of the minimum value. Accordingly, the storage devices 20 are capable of starting the log transmission at a time at which the log transmission has a low impact on the business operation.

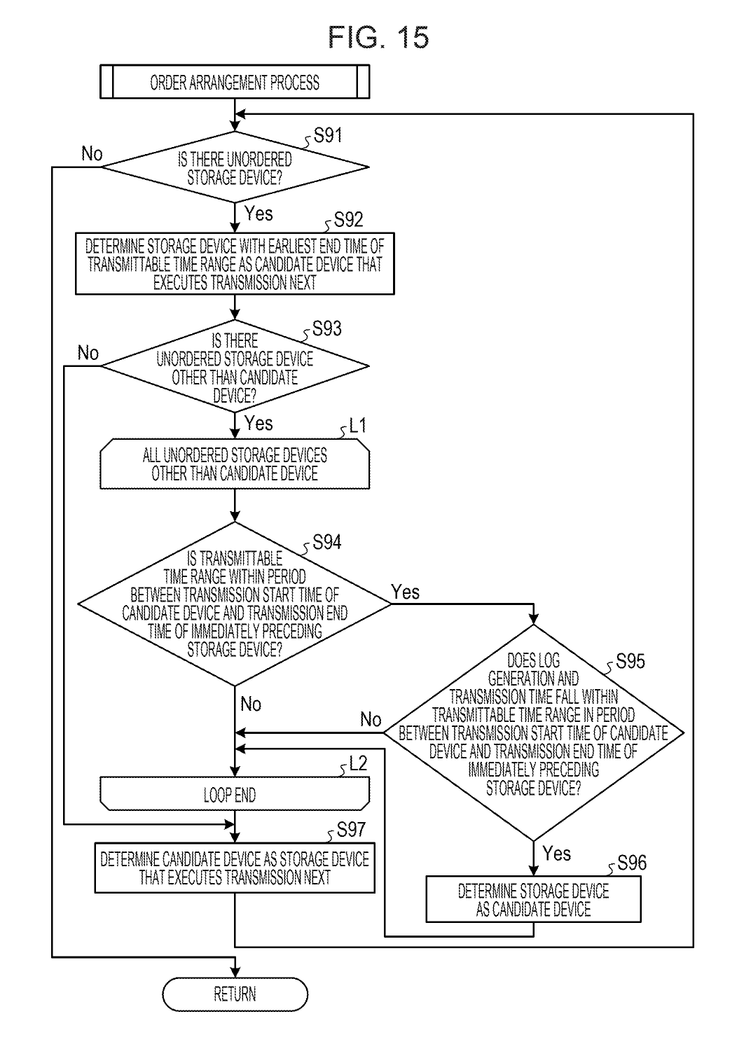

FIG. 15 is a flowchart illustrating flow of the order arrangement process. As illustrated in FIG. 15, the log analyzing unit 35 determines whether there is an unordered storage device 20 (step S91). If there is no unordered storage device 20, the log analyzing unit 35 completes the order arrangement process.

Meanwhile, if there is an unordered storage device 20, the log analyzing unit 35 determines the storage device 20 having the earliest end time of the transmittable time range as a candidate device that executes the log transmission next (step S92). If there are a plurality of storage devices 20 having the earliest end time of the transmittable time range, the log analyzing unit 35 selects the candidate device in the order of smallest sum of LIA values of all of the storage devices 20. The log analyzing unit 35 then determines whether there is an unordered storage device 20 other than the candidate device (step S93). If there is no unordered storage device 20 other than the candidate device, the log analyzing unit 35 proceeds to step S97.

Meanwhile, if there is an unordered storage device 20 other than the candidate device, the log analyzing unit 35 performs the following processes of steps S94 to S96, which are described between loop-limit symbols L1 and L2, on all unordered storage devices 20 other than the candidate device (as indicated in the loop-limit symbol L1).

That is, the log analyzing unit 35 determines whether the transmittable time range of the storage device 20 being processed is included in the period between the transmission start time of the candidate device and the transmission end time of the storage device 20 immediately preceding the candidate device (step S94). Then, if the transmittable time range of the storage device 20 is not included in the above-described period, the log analyzing unit 35 processes the next storage device 20. Meanwhile, if the transmittable time range of the storage device 20 is included in the above-described period, the log analyzing unit 35 determines whether the log generation and transmission time of the storage device 20 falls within the transmittable time range in the period between the transmission start time of the candidate device and the transmission end time of the storage device 20 immediately preceding the candidate device (step S95). Then, if the log generation and transmission time does not fall within the transmittable time range, the log analyzing unit 35 processes the next storage device 20. Meanwhile, if the log generation and transmission time falls within the transmittable time range, the log analyzing unit 35 determines the storage device 20 being processed as the candidate device (step S96), and processes the next storage device 20.

Then, after the completion of the processes of steps S94 to S96 on all unordered storage devices 20 other than the candidate device, the log analyzing unit 35 determines the candidate device as the storage device 20 that executes the log transmission next (step S97).

The log analyzing unit 35 is capable of determining the log transmission start times by thus determining the log transmission order of the storage devices 20 based on the transmittable time ranges, the log generation and transmission times, and the load indices.

As described above, in the embodiment example, the calculating unit 35a of the log analyzing unit 35 calculates the load index of each of the storage devices 20 based on the log generation time, the log transmission time, and the log. Then, the identifying unit 35b identifies the transmittable time range of the storage device 20 based on the load index. Then, the order determining unit 35c determines the order of log transmission of the plurality of storage devices 20 based on the transmittable time ranges, the log generation and transmission times, and the load indices of the plurality of storage devices 20. Then, the time determining unit 35d determines the respective log transmission start times of the storage devices 20 based on the respective transmittable time ranges of the storage devices 20 and the order determined by the order determining unit 35c. Accordingly, the cloud 3 is capable of reducing the degradation in performance of the business operation due to the log transmission by the storage devices 20.

Further, in the embodiment example, the order determining unit 35c determines the order of log transmission of the plurality of storage devices 20 based on the end times of the respective transmittable time ranges of the storage devices 20. Accordingly, it is possible to reduce situations in which any of the storage devices 20 is unable to complete the log transmission within the transmittable time range.

Further, in the embodiment example, if two or more of the storage devices 20 have the same end time of the transmittable time range, the order determining unit 35c calculates the sum of load indices of all of the storage devices 20 for each of all possible orders in which the two or more of the storage devices 20 are rearranged. The order determining unit 35c then determines the order of the two or more of storage devices 20 based on the calculated sum. Accordingly, the order determining unit 35c is capable of reducing the degradation in performance of the business operation due to the log transmission by the storage devices 20.

Further, in the embodiment example, the order determining unit 35c selects the storage device 20 that executes the log transmission next as the candidate device. Then, if there is another storage device 20 capable of starting and completing the log transmission during the period between the transmission start time of the candidate device and the transmission end time of the storage device 20 immediately preceding the candidate device, the order determining unit 35c selects the another storage device 20 as the candidate device. Further, if there is no other storage device 20 capable of starting and completing the log transmission during the period between the transmission start time of the candidate device and the transmission end time of the storage device 20 immediately preceding the candidate device, the order determining unit 35c determines the candidate device as the storage device 20 that executes the log transmission next. Accordingly, the order determining unit 35c is capable of reducing situations in which any of the storage devices 20 is unable to complete the log transmission within the transmittable time range.

Further, in the embodiment example, if any of the storage devices 20 has the urgent log, the order determining unit 35c divides the storage devices 20 into storage devices 20 with the urgent log flag and storage devices 20 without the urgent log flag, and prioritizes, in order, the storage devices 20 with the urgent log flag. Accordingly, the cloud 3 is capable of preferentially analyzing the logs of the storage devices 20 with the urgent log.

Further, in the embodiment example, if any of the storage devices 20 is unable to complete the log transmission within the transmittable time range, the log analyzing unit 35 increases the range of neighboring values of the minimum LIA value. Accordingly, the log analyzing unit 35 is capable of reducing situations in which any of the storage devices 20 is unable to complete the log transmission within the transmittable time range.

Further, in the embodiment example, the log analyzing unit 35 operates in the cloud 3. If there is no log of the user environment 2, therefore, the log analyzing unit 35 is capable of determining the log transmission start time by using the log of another storage device included in the cloud 3.

Further, in the embodiment example, the cloud 3 has been described. If the configuration of the cloud 3 is implemented by software, a log management program having functions similar to those of the cloud 3 is obtainable. A computer that executes the log management program will now be described.

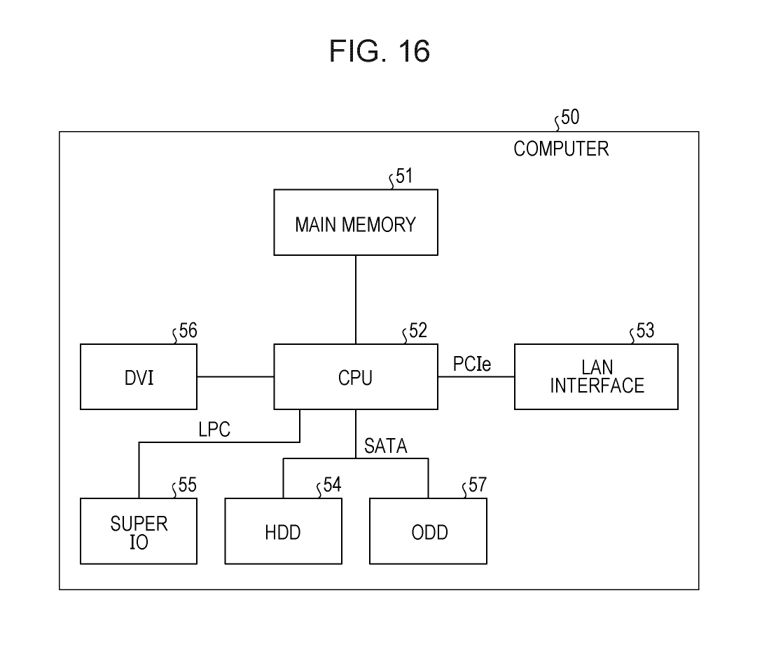

FIG. 16 is a diagram illustrating a hardware configuration of the computer that executes the log management program according to the embodiment example. As illustrated in FIG. 16, a computer 50 includes a main memory 51, a CPU 52 as an example of a processor, a local area network (LAN) interface 53, and an HDD 54. The computer 50 further includes a super input output (IO) 55, a digital visual interface (DVI) 56, and an optical disk drive (ODD) 57.

The main memory 51 is a memory that stores, for example, a program and intermediate results of the program being executed. The CPU 52 is a central processing unit that reads and executes the program from the main memory 51. The CPU 52 includes a chip set having a memory controller.

The LAN interface 53 is an interface for connecting the computer 50 to another computer via a LAN. The HDD 54 is a disk device that stores a program and data. The super IO 55 is an interface for connecting the computer 50 to input devices such as a mouse and a keyboard. The DVI 56 is an interface for connecting the computer 50 to a liquid crystal display device. The ODD 57 is a device that reads from and writes to a digital versatile disc (DVD) or a compact-disc-recordable (CD-R).

The LAN interface 53 is connected to the CPU 52 by a peripheral component interconnect express (PCIe) bus. The HDD 54 and the ODD 57 are connected to the CPU 52 by a serial advanced technology attachment (SATA) bus. The super IO 55 is connected to the CPU 52 by a low pin count (LPC) bus.

Further, the log management program executed in the computer 50 is stored in a CD-R as an example of a recording medium readable by the computer 50, and is read from the CD-R and installed into the computer 50 by the ODD 57. Alternatively, the log management program is stored in, for example, a database of another computer system connected to the computer 50 via the LAN interface 53, and is read from the database and installed into the computer 50. Then, the installed log management program is stored in the HDD 54, read into the main memory 51, and executed by the CPU 52.

Further, in the embodiment example, a description has been given of the case in which the cloud 3 determines the log transmission start times. The log transmission start times, however, may be determined by a log management apparatus that manages the logs of the storage devices 20.

Further, in the embodiment example, a description has been given of the case in which the cloud 3 determines the log transmission start times of the storage devices 20. The cloud 3, however, may determine the log transmission start time of another log collection target device.

Further, in the embodiment example, the log transmission time is determined as the time from the start to the completion of the log reception by the cloud 3. For example, however, the log transmission time may be determined as another time, such as the time from the start of the log transmission by the storage device 20 to the completion of the log reception by the cloud 3.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A log management apparatus comprising:
a memory; and
a processor coupled to the memory and configured to:
calculate a load index for each of a plurality of log collection target devices, based on a log generation time taken for log generation in each of the plurality of log collection target devices and a log transmission time taken for log transmission from each of the plurality of the log collection target devices,
identify a plurality of log transmittable time ranges of the plurality of log collection target devices, based on the calculated load index,
determine an order of log transmission of the plurality of log collection target devices, based on the identified plurality of log transmittable time ranges, and
determine, based on the order and the plurality of log transmittable time ranges of the plurality of log collection target devices, respective times at which the plurality of log collection target devices execute the log transmission process.

2. The log management apparatus according to claim 1, wherein
the processor is configured to determine the order, based on respective end times of the plurality of log transmittable time ranges.

3. The log management apparatus according to claim 2, wherein,
when two or more of the plurality of log collection target devices are in a same rank in the order determined based on the respective end times of the plurality of log transmittable time ranges, the processor calculates a sum of load indices of all of the plurality of log collection target devices for each of all possible orders in which the two or more of the plurality of log collection target devices are rearranged, and determines the order of all of the plurality of log collection target devices, based on the calculated sum.

4. The log management apparatus according to claim 2, wherein
in a case of selecting, as a candidate device, one of the plurality of log collection target devices that executes the log transmission next, when another one of the plurality of log collection target devices is capable of starting and completing the log transmission during a period between a transmission start time of the candidate device and a transmission end time of one of the plurality of log collection target devices immediately preceding the candidate device, the processor selects the another one of the plurality of log collection target devices as the candidate device in determining the order.

5. The log management apparatus according to claim 1, wherein
when the plurality of log collection target devices include an urgent device having an urgent log, the processor prioritizes the urgent device in determining the order.

6. The log management apparatus according to claim 1, wherein
the processor is further configured to, when any of the plurality of log collection target devices is unable to complete the log transmission within a corresponding one of the plurality of log transmittable time ranges, control and increase the corresponding one of the plurality of log transmittable time ranges.

7. A method comprising:
calculating a load index for each of a plurality of log collection target devices, based on a log generation time taken for log generation in each of the plurality of log collection target devices and a log transmission time taken for log transmission from each of the plurality of the log collection target devices;
identifying a plurality of log transmittable time ranges of the plurality of log collection target devices, based on the calculated load index;
determining an order of log transmission of the plurality of log collection target devices, based on the identified plurality of log transmittable time ranges; and
determining, based on the order and the plurality of log transmittable time ranges of the plurality of log collection target devices, respective times at which the plurality of log collection target devices execute the log transmission process.

8. A non-transitory, computer-readable recording medium having stored therein a program for causing a computer to execute a process comprising:
calculating a load index for each of a plurality of log collection target devices, based on a log generation time taken for log generation in each of the plurality of log collection target devices and a log transmission time taken for log transmission from each of the plurality of the log collection target devices;
identifying a plurality of log transmittable time ranges of the plurality of log collection target devices, based on the calculated load index;
determining an order of log transmission of the plurality of log collection target devices, based on the identified plurality of log transmittable time ranges; and
determining, based on the order and the plurality of log transmittable time ranges of the plurality of log collection target devices, respective times at which the plurality of log collection target devices execute the log transmission process.
